(19) United States
(12) Patent Application Publication
(10) Pub. No.: US 2006/0188155 A1
(43) Pub. Date: Aug. 24, 2006

(54) Color signal processing method

(75) Inventor: Hisashi Matsuyama, Ogaki-shi (JP)

Correspondence Address: OLIFF & BERRIDGE, PLC, P.O. BOX 19928, ALEXANDRIA, VA, 22320, US

(73) Assignee: Sanyo Electric Co., Ltd., Osaka (JP)

(21) Appl. No.: 11/357,178

(22) Filed: Feb. 21, 2006

(30) Foreign Application Priority Data
Feb. 22, 2005 (JP) 2005-046020

(51) Int. Cl. G06K 9/00

(52) U.S. Cl. 382/167

(57) ABSTRACT

The invention alleviates a load in color signal processing for a color component signal containing an offset signal component owing to infrared light. In a case where the respective color component signals <R>, <G> and <B> are substantially the same as <IR>, each of the color component signals is almost made of an offset signal component, and a signal component corresponding to an intrinsic wavelength region of each of R, G and B is slight. In this case, calculations for obtaining color difference signals Cr and Cb are omitted and a monochrome signal made of only a brightness signal Y is generated. On the other hand, in the case of the <IR> being substantially 0, when generating Y, Cr and Cb, a compensation process for removing influence due to the offset signal component is omitted.

### CROSS-REFERENCE TO RELATED APPLICATIONS

The priority application number JP2005-046020 upon which this patent application is based is hereby incorporated by reference.

### BACKGROUND OF THE INVENTION

1. Field of the Invention

The invention relates to a color signal processing method capable of coping with a plurality of color component signals that are corresponding to color components different from each other and respectively include an offset signal component associated with a non-targeted wavelengths.

2. Description of the Related Art

A solid-state imaging device such as a CCD (Charge Coupled Device) image sensor that is mounted on a video camera or a digital camera has light receiving elements arranged two-dimensionally, the light receiving elements photoelectrically converting incident light to generate an electrical image signal. The light receiving elements each include a photodiode formed on a semiconductor substrate, the photodiode itself having the spectral sensitivity characteristics common in all light receiving elements. Accordingly, in order to obtain a color image, a plurality of kinds of color filters different in colors of transmission light, that is, transmission wavelength regions, are disposed on the photodiode.

As to the color filter, there are a primary color based set of filters each of which has transmission light of red (R), green (G) or blue (B), and a complementary color based set of filters each of which corresponds to cyan (Cy), magenta (Mg) or yellow (Ye). The color filters can be obtained by coloring an organic base material, each allowing visible light of a corresponding color to transmit. Furthermore, each of the color filters transmits not only a visible light corresponding to coloring, but also, from a viewpoint of the nature of the base material, infrared light. The light transmission of each of the color filters of the respective colors shows intrinsic spectral characteristics corresponding to the respective colorings in a visible light region and substantially common spectral characteristics in an infrared region.

On the other hand, the photodiode has sensitivity, in addition to the entire visible light region which is a wavelength region substantially from 380 to 780 nm, up to a near infrared region in a further longer wavelength region. Accordingly, when an infrared light component (IR component) enters a light receiving element, the infrared light component transmits through the color filter and generates signal charges at the photodiode. FIG. 1 is a graph showing the spectral sensitivity characteristics of the respective light receiving elements of R, G and B, each of which is provided with an R, G or B filter. As shown as well in FIG. 1, since the respective light receiving elements also have sensitivity to the IR component, correct color representation cannot be achieved to incident light including the IR component. Accordingly, so far, between a camera lens and a solid-state imaging device, an infrared red cut filter is separately disposed.

The infrared cut filter cuts the infrared light and, simultaneously, attenuates the visible light by substantially 10 to 20%. Accordingly, there is a problem in that the intensity of visible light entering the light receiving element is reduced, the S/N ratio of an output signal is lowered accordingly, and as a result image quality is deteriorated.

As a countermeasure to this problem, there is proposed a solid-state imaging device that, on one hand, can do without an infrared cut filter and, on the other hand, has, in addition to light receiving elements (particular color light receiving elements) provided with color filters that transmit light components of particular colors of R, G and B, a light receiving element (IR receiving element) that detects fundamentally only the IR component in the incident light.

The signal outputted from the IR receiving element (reference signal) gives information relating to an amount of signal generated owing to the IR component in each of the light receiving elements. By use of the reference signal, color signal processing where the IR component contained in each of the color signals outputted from the light receiving elements of particular colors is inhibited from influencing can be carried out.

In the color signal processing where the IR component is removed, an IR component superimposed as an offset signal on a color component signal obtained at each of the particular color receiving elements is estimated based on the reference signal obtained from the IR light receiving element. Accordingly, as a ratio of the IR component in each of the color component signals becomes larger, owing to an error of estimation thereof, after the component is removed a color expressed by a minute signal tends to be inaccurate. Thus, there is a problem in that the IR component removal calculation is not necessarily always effective.

[Patent document 1] JP-A-2005-184690

### SUMMARY OF THE INVENTION

The invention provides a color signal processing method that alleviates processing load and improves processing speed of a color component signal containing an offset signal component involving wavelengths other than a target wavelength.

A color signal processing method according to the invention is a method that uses a reference signal corresponding to a light component of an offset component band and a plurality of kinds of color component signals where each of signal components corresponding to light components of particular colors different from each other and an offset signal component corresponding to a light component of the offset component band are combined. The processing method includes an offset domination detection step where a ratio of the offset signal component in each of the color component signals is evaluated based on the reference signal to detect an offset domination state where the ratio for each of the color component signals is equal to or more than a predetermined threshold value, a monochrome signal generation step where, in the case of the offset domination, based on each of the color component signals, a monochrome signal is generated, and a color signal generation step where, in the case of other than the offset domination, a chromatic color signal is generated corresponding to each of the color component signals.

According to the invention, in the case of a ratio of the offset signal component in the color component signal being large, based on the color component signal containing the offset signal component, a monochrome signal is generated. Accordingly, it is possible to avoid displaying with inaccurate colors from signals obtained according to the color signal processing . At that time, a process of removing the offset signal component can be omitted. This can alleviates the processing load and improves the processing speed.

### BRIEF DESCRIPTION OF THE DRAWINGS

FIG. 1 is a graph showing spectral sensitivity characteristics of the respective light receiving elements of R, G and B.

FIG. 2 is a block diagram showing a schematic configuration of an imaging device involving an embodiment according to the invention.

FIG. 3 is a schematic flow chart for describing a color signal processing method involving the embodiment according to the invention.

### DESCRIPTION OF THE PREFERRED EMBODIMENTS

In what follows, a mode of implementing the invention (hereinafter, referred to as an embodiment) will be described with reference to the drawings.

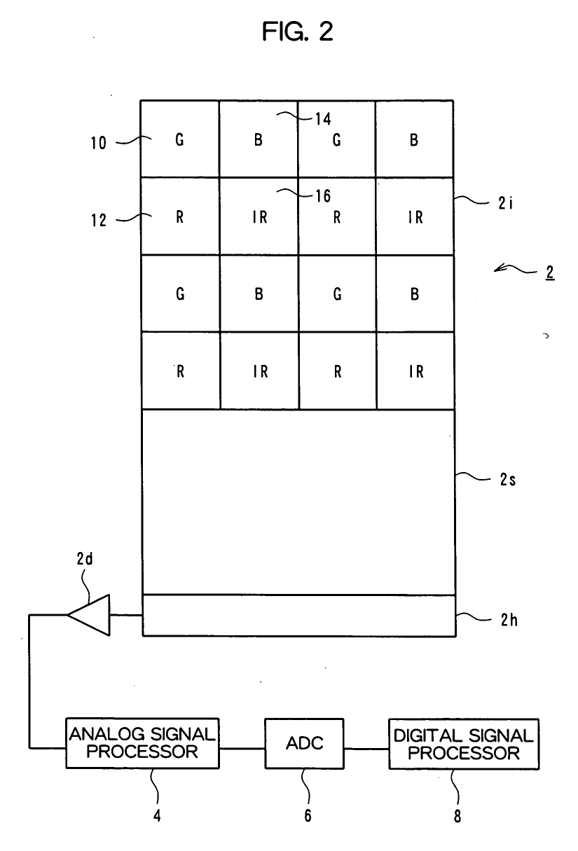

FIG. 2 is a block diagram showing a schematic configuration of an imaging device involving the embodiment. The imaging device includes a CCD image sensor 2, an analog signal processor 4, an A/D converter 6 and a digital signal processor 8.

The CCD image sensor 2 shown in FIG. 2 is a frame-transfer type and constituted including an imaging portion 2i, a storage portion 2s, a horizontal transfer portion 2h and an output portion 2d that are formed on a semiconductor substrate.

Each of bits of a vertical shift register that constitutes the imaging portion 2i functions as a light receiving element that respectively forms a pixel.

Each of the light receiving elements is provided with a color filter and in accordance with the transmission characteristics of the color filter a light component to which the light receiving element has sensitivity is determined. Here, an arrangement of 2×2 pixels constitutes a unit of an arrangement of the light receiving element. For instance, light receiving elements 10, 12, 14 and 16 constitute the unit.

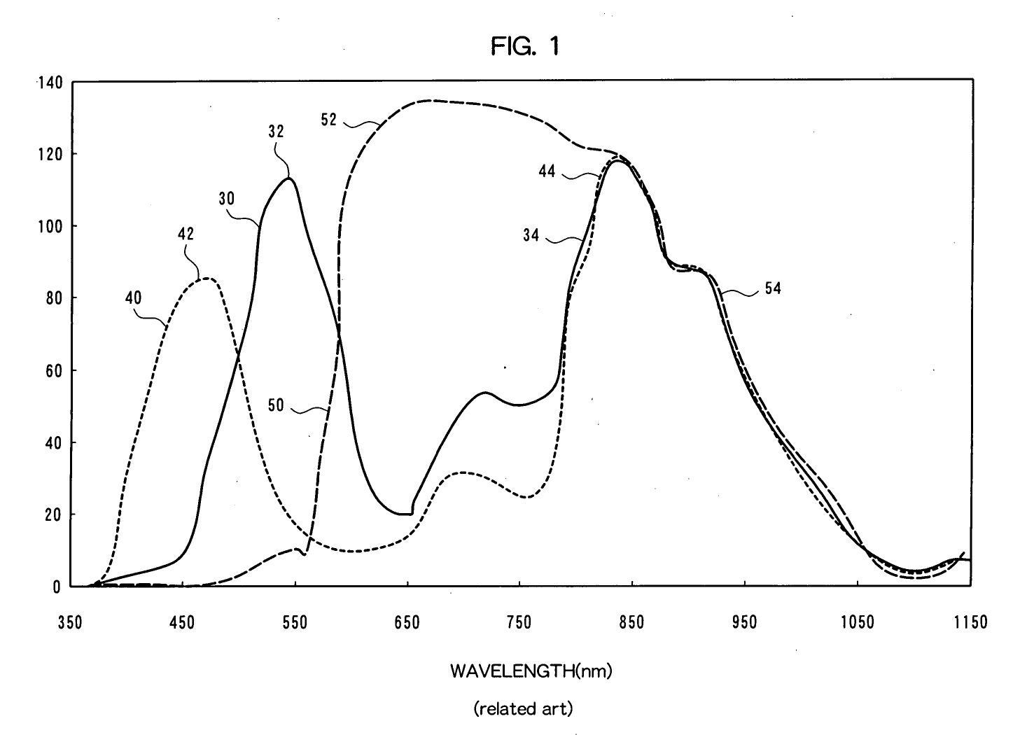

A light receiving element 10 is a G light receiving element on which a G filter is disposed. The light receiving element 10 responds to incident light including not only visible light but also an IR component as shown with a line 30 of FIG. 1 to generate signal charges corresponding to a G component 32 and an IR component 34. A light receiving element 12 is an R light receiving element on which an R filter is disposed. The light receiving element 12, as shown with a line 50 of FIG. 1, generates signal charges corresponding to an R component 52 and an IR component 54. A light receiving element 14 is a B light receiving element on which a B filter is disposed. The light receiving element 14, as shown with a line 40 of FIG. 1, generates signal charges corresponding to a B component 42 and an IR component 44.

A light receiving element 16 is an IR light receiving element that is provided thereon with an IR filter (infrared transmitting filter) that selectively transmits an IR component and generates signal charges corresponding to an IR component in incident light. The IR filter can be constituted by laminating the R filter and the B filter. The reason for this is that since a B component that transmits the B filter in visible light does not transmit the R filter and on the other hand an R component that transmits the R filter does not transmit the B filter, when the incident light is allowed to go through both filters, fundamentally the visible light component is removed and only the IR component that transmits both filters remains in transmitted light.

In the imaging portion 2i, the arrangement of 2×2 pixels is arranged repeatedly in a vertical direction and a horizontal direction, respectively.

The CCD image sensor 2 is driven by a clock pulse and the like supplied from a not shown driving circuit, signal charges generated in each of the light receiving elements of the imaging portion 2i are transferred through the storage portion 2s and the horizontal transfer portion 2h to the output portion 2d. The output portion 2d converts the signal charges outputted from the horizontal transfer portion 2h into a voltage signal to output as an image signal.

An analog signal processor 4 applies processes such as an amplification or sample-and-hold operation to an image signal that is an analog signal outputted from the output portion 2d. An ADC (Analog-to-Digital Converter) 6 converts the image signal outputted from the analog signal processor 4 to digital data of predetermined quantifying bit number to generate image data, followed by outputting the image data. For instance, the ADC 6 carries out the A/D conversion to an 8-bit digital value, and as a result the image data are expressed with a value in the range of 0 to 255.

The digital signal processor 8 takes in image data from the ADC 6 and variously processes the data. For instance, the digital signal processor 8 applies a spatial interpolation process to the image data. Owing to the interpolation process, for each of sampling points corresponding to positions of the light receiving elements, image data for each of which R, G, B and IR data is defined are generated from image data that selectively gives any one of R, G, B and IR data image data, at each of the sampling points. The data corresponding to the R, G, B and IR, respectively, are expressed with <R>, <G>, <B> and <IR>. The digital signal processor 8 further processes the data to generate brightness data (brightness signal) Y and color difference data (color difference signal) Cr and Cb at each of the sampling points.

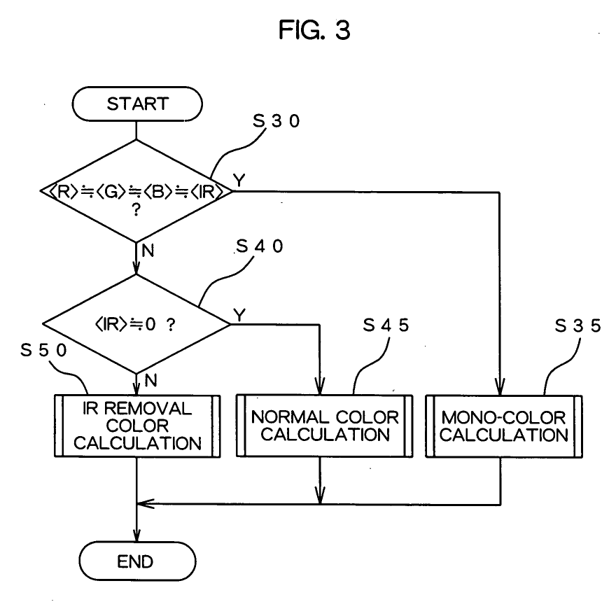

In the following, a color signal processing method for generating Y, Cr and Cb will be described. FIG. 3 is a schematic flow chart describing the color signal processing method. Of the <R>, <G> and <B>, when signal components corresponding to the R, G and B components of incident light are expressed with R₀, G₀ and B₀ and the offset signal components corresponding to infrared light are expressed with Ir, Ig and Ib, equations below hold.
<R>=R₀+Ir
<G>=G₀+Ig (1)
<B>=B₀+Ib

The digital signal processor 8 evaluates ratios of the offset signal components Ir, Ig and Ib in the <R>, <G> and <B> based on the <IR> and further detects the offset domination state where the ratio is equal to or more than a predetermined threshold value. In a process where the offset state is judged, the transmission characteristics of the color filters disposed to each of the RGB light receiving elements and the IR filter disposed to the IR light receiving element and difference of areas between each of the light receiving elements and the IR light receiving element, and the like are taken into consideration. Information concerning the factors is acquired in advance and reflected in processing in the digital signal processor 8. Here, since as mentioned above the IR filter is made of a base material the same as that of the R, G and B filters, the transmission characteristics with respect to infrared light of the respective filters are fundamentally the same. Furthermore, areas of the respective light receiving elements are constituted fundamentally the same. From these, substantially, the relationship of
Ir=Ig=Ib=<IR> (2)
can be obtained. By making use of this relationship, the digital signal processor 8 judges whether an equation below substantially holds or not (S30).
<R>=<G>=<B>=<IR> (3)

A case where it is assumed that the equation holds is a case where almost all components of the <R>, <G> and <B> are Ir, Ig and Ib, and the signal components R₀, G₀ and B₀ corresponding to wavelength regions of each of R, G and B of the incident light are slight. The digital signal processor 8 judges a case when the equation is assumed to hold to be the offset domination state and carries out a mono-color calculation S35.

For instance, the digital signal processor 8, as a step S30, calculates the respective ratios <IR>/<R>, <IR>/<G> and <IR>/<B> of each of the sampling points, and when all of average values in one image plane of the respective ratios are equal to or more than a predetermined threshold value η, judges as the offset domination state. The threshold value η is set at a value smaller than 1 and close to 1. On the other hand, when an average value of any one of the ratios is smaller than the threshold value η, the state is judged to be not offset-dominant.

In the mono-color calculation S35, with the <R>, <G> and <B>, the brightness data Y alone is generated and calculations for generating the color difference data Cr and Cb are omitted. As a result, in the mono-color calculation S35, the processing load can be alleviated and the processing speed can be improved. Image data generated by the mono-color calculation S35 become a monochrome image signal expressing an infrared light image.

On the other hand, the digital signal processor 8, when judging in the step S30 that the state is not offset-dominant, generates color image signals expressing a visible light image based on the respective signal components corresponding to the respective wavelength regions of R, G and B of the incident light. In the step of generating the color image signals, the digital signal processor 8 at first judges whether or not the state is a slight offset state where the offset signal components Ir, Ig and Ib are slight. Here, by making use of equation (2), based on whether the <IR> is substantially slight or not, the judgment of the slight offset state is carried out (S40).

For instance, the digital signal processor 8, as the step S40, when an average value in one image plane of the <IR> is equal to or less than a predetermined threshold value ξ, judges that the state is a slight offset state. The threshold value ξ is set to a positive number close to 0. On the other hand, when the average value of the <IR> is larger than the threshold value ξ, the state is judged to be not the slight offset state.

The digital signal processor 8, when judging that the state is the slight offset state, applies a normal color calculation S45 to <R>, <G> and <B>. In the normal color calculation, Y, Cr and Cb are obtained from following equations of the respective components of R, G and B.
Y≡αR+βG+γB (4)
Cr≡λ(R−Y) (5) and
Cb≡μ(B−Y) (6)

Here, α, β, γ, λ and μ are coefficients, and in particular between α, β and γ, a relationship of
α+β+γ=1
holds.

Fundamentally, the calculations (4) through (6) have to be carried out with, as the R, G and B, R₀, G₀ and B₀ left after the offset signal components are removed. However, the digital signal processor 8, when judging to be the slight offset state, with the <R>, <G> and <B> as the R, G and B, calculates Y, Cr and Cb from the equations (4) through (6). That is, in the normal color calculation S45, with the offset signal components Ir, Ig and Ib neglected in the <R>, <G> and <B> and with the <R>, <G> and <B>, respectively, assumed as the signal components R₀, G₀ and B₀ themselves corresponding to the respective wavelength regions of the R, G and B of the incident light, the brightness data Y and the color difference data Cr and Cb are generated.

The digital signal processor 8, when it has been judged in the step S40 to not be the slight offset state, carries out an IR removal color calculation S50 to calculate Y, Cr and Cb. The IR removal color calculation S50 carries out a compensation process corresponding to the offset signal components Ir, Ig and Ib based on the <IR> to generate Y, Cr and Cb where influences generated by the offset signal components Ir, Ig and Ib are removed or alleviated.

The compensation process is applied in the IR removal color calculation S50, in contrast, in the normal color calculation S45 since the compensation process is omitted the processing load can be alleviated and the processing speed improved.

The above-described color signal processing method according to the invention is a method that uses a reference signal corresponding to a light component of an offset component band and a plurality of kinds of color component signals in each of which a signal component corresponding to a light component of each of particular colors different from each other and an offset signal component corresponding to a light component of the offset component band are combined. In particular, the color signal processing method includes an offset domination detection step where a ratio of the offset signal component in each of the color component signals is evaluated based on the reference signal to detect an offset domination state where the ratio of each of the color component signals is equal to or more than a predetermined threshold value, and, in the case of the offset domination, as a monochrome signal generation step where, based on each of the color component signals, a monochrome signal is generated, the mono-color calculation S35 is carried out, and, in the case of other than the offset domination, a color signal generation step where a chromatic color signal corresponding to each of the color component signals is generated is carried out.

In the color signal generation step, based on the reference signal, the compensation process is carried out according to the offset signal component, and an IR removing calculation S50 is carried out to generate a compensated chromatic color signal.

Furthermore, the color signal generation step, in the judgment step S40, detects a slight offset state where the reference signal is equal to or less than a predetermined threshold value. In the case of the slight offset state, without carrying out the compensation step, the normal color calculation S45 is carried out to generate the chromatic color signal.

The offset domination detection step can be configured so that, for instance, like the judgment step S30 in the above configuration, a case where the respective color component signals are values in accordance with the reference signal may be detected as the offset domination state.

According to the invention, when a ratio of the offset signal component in the color component signal is large, based on the color component signal containing the offset signal component, a monochrome signal is generated. Accordingly, it is possible to avoid the situation where, owing to the signal obtained in the color signal processing, inaccurate color display is carried out, and, at that time, since a step of removing the offset signal component can be omitted, processing load can be alleviated and higher speed can be obtained. Furthermore, when the offset signal is small, the compensation step such as removing the offset signal component is omitted, and a color signal such as the color difference signal corresponding to the color component signals is generated. The processing load can be alleviated and processing speed improved by the extent to which the compensation step is omitted.

What is claimed is:

1. A color signal processing method that uses a reference signal corresponding to a light component of an offset component band and a plurality of kinds of color component signals where a signal component corresponding to a light component of each of particular colors different from each other and an offset signal component corresponding to a light component of the offset component band are combined, comprising:
detecting an offset domination state where a ratio of the offset signal component in each of the color component signals is evaluated based on the reference signal to detect an offset domination state where the ratio for each of the color component signals is equal to or more than a predetermined threshold value;
generating a monochrome signal where, in the case of the offset domination state, based on each of the color component signals, a monochrome signal is generated; and
generating a color signal where, in the case of a state other than the offset domination state, a chromatic color signal corresponding to each of the color component signals is generated.

2. The color signal processing method according to claim 1, wherein the generating of a color signal, based on the reference signal, carries out a compensation process corresponding to the offset signal component to generate a compensated chromatic color signal.

3. The color signal processing method according to claim 2, wherein the generating of a color signal further includes:
detecting a slight offset state where the reference signal is equal to or less than a predetermined threshold value; and
in the case of the slight offset signal, generating the chromatic color signal without applying the compensation process.

4. The color signal processing method according to claim 1, wherein the detecting of an offset domination state detects a case where each of the color component signals is a value in accordance with the reference signal as the offset domination state.
